(19) United States
(12) Patent Application Publication
(10) Pub. No.: US 2024/0424764 A1
(43) Pub. Date: Dec. 26, 2024

(54) A METHOD FOR PRODUCING A SOLID POLYURETHANE COMPOSITE CONTAINING BIOMASS AND A SOLID POLYURETHANE COMPOSITE PRODUCED BY SAID METHOD AND A METHOD OF PRODUCING A FOAMED POLYURETHANE COMPOSITE CONTAINING BIOMASS AND A FOAMED POLYURETHANE COMPOSITE PRODUCED BY SAID METHOD

(71) Applicant: NEXTGEN MATERIALS SPÓLKA Z OGRANICZONA ODPOWIEDZIALNOSCIA, RADZYN PODLASKI (PL)

(72) Inventors: Mateusz Toporowicz; Lukasz Piszczyk

(21) Appl. No.: 18/263,390

(22) PCT Filed: Jan. 25, 2022
(86) PCT No.: PCT/PL2022/000001

§ 371 Date: Jul. 28, 2023

(30) Foreign Application Priority Data
Jan. 28, 2021 (PL) P.436787

(51) Int. Cl. B32B 9/04; B32B 9/02; B32B 27/40; C08G 18/22

(52) U.S. Cl. CPC B32B 9/045; B32B 9/02; B32B 27/40; C08G 18/225; B32B 2266/0278; B32B 2307/7376; B32B 2375/00; B32B 2413/00; B32B 2439/06; B32B 2601/00

(57) ABSTRACT

The invention relates to a method for producing a solid polyurethane composite containing biomass and a solid polyurethane composite produced by said method and a method of producing a foamed polyurethane composite containing biomass and a foamed polyurethane composite produced by said method. A method for producing a solid polyurethane composite containing biomass according to the invention, formed with a polyurethane layer prepared from oligomers, polyisocyanates, extenders, catalysts. The production method is characterised in that a layer of biomass-containing polyurethane is applied onto a support, wherein the applied layer of biomass-containing polyurethane has a thickness of 50 μm to 300 μm, then this is dried in a drying chamber at a temperature of up to 80° C. to 150° C. for 1 to 180 min, and another layer of biomass-containing polyurethane with a thickness of 300 to 1500 μm is applied onto the dried layer of biomass-containing polyurethane onto which a surface material is applied, and then this is rolled on rolls, followed by baking in a baking chamber at a temperature of 80° C. to 150° C. for 1 to 180 minutes. after which the support is separated; A solid polyurethane composite containing biomass obtained using the method according to the invention and formed with polyurethane layers. The solid composite is characterised in that the polyurethane layers (29,30) are stacked one on another and have a thickness of 50 to 1500 μm, wherein each polyurethane layer (29,30) as polyols contains bio-polyols of plant origin with a molecular weight of 100 to 6000 g/mol, a functionality of 1 to 4 and a hydroxyl number from 30 to 600 mg KOH/g, and one surface of the combined polyurethane layers (29,30) is coated with a surface material (20), while one of the polyurethane layers (29,30) contains 1 to 90% citrus fruit biomass in crushed form. A method for producing a foamed polyurethane composite containing biomass according to the invention formed with a layer of polyurethane prepared from oligomers, polyisocyanates, extenders, catalysts The production method is characterised in that a layer of biomass-containing polyurethane is applied onto a support, wherein the applied layer of biomass-containing polyurethane has a thickness of 50 μm to 450 μm, followed by foaming in a foaming chamber and drying in a drying chamber at a temperature of up to 80° C. to 100° C. for 20 to 180 mins, and another layer of biomass-containing polyurethane with a thickness of 300 μm to 1500 μm is applied onto the dried layer of biomass-containing polyurethane onto which a surface material is applied, and then this is rolled on rolls, followed by baking in a baking chamber at a temperature of 80° C. to 150° C. for 1 to 180 minutes, after which the support is separated. A foamed polyurethane composite containing biomass obtained using the method according to the invention and formed with polyurethane layers. The foam polyurethane composite containing biomass is characterised in that the polyurethane layers (29, 30) are stacked one on another and have a thickness of 50 μm to 3500 μm, wherein the first polyurethane layer (29) is foamed, and each polyurethane layer (29, 30) as polyols contains bio-polyols of plant origin with a molecular weight of 100 to 6000 g/mol, a functionality of 1 to 4 and a hydroxyl number from 30 to 600 mg KOH/g, and one surface of the combined polyurethane layers (29, 30) is coated with a surface material (20), while one of the polyurethane layers (29, 30) contains 1 to 90% citrus fruit biomass in crushed form.

A method for producing a solid polyurethane composite containing biomass and a solid polyurethane composite produced by said method and a method of producing a foamed polyurethane composite containing biomass and a foamed polyurethane composite produced by said method

The invention relates to a method for producing a solid polyurethane composite containing biomass and a solid polyurethane composite produced by said method and a method of producing a foamed polyurethane composite containing biomass and a foamed polyurethane composite produced by said method.

Application P.320223 P1 discloses biodegradable polyetheresters prepared by reacting a mixture consisting essentially of (a1) a mixture consisting essentially of 20 to 95 mol % adipic acid or ester derivatives thereof or mixtures thereof from 5 to 80 mol % terephthalic acid or ester derivatives thereof or mixtures thereof and 0 to 5 mol % of a compound containing sulphonate groups, with the total of the individual data relating to molar percentages representing 100%, and of (a2) a mixture of dihydroxy compounds consisting essentially of (a21) from 15 to 99.8 mol % of a dihydroxy compound of a group of compounds consisting of alkanediols containing 2 to 6 carbon atoms and cycloalkanediols containing 5 to 10 carbon atoms, (a22) from 85 to 0.2 mol % of a dihydroxy compound containing ether groups, with the formula HO[(CH2)N—O]m-H, where n is 2,3 or 4, and m is an integer of 2 to 250, or of mixtures thereof, wherein the molar ratio (a 1) to (a2) selected is in the range of 0.4:1 to 1.5:1, wherein the polyetherester P1 has a molecular weight (Mn) in the range of 5000 to 80000 g/mol, a viscosity number in the range of 30 to 450 g/ml (measured in an o-dichlorobenzene/phenol mixture with a 50/50 weight ratio at a concentration of 0.5% by weight of the polyester P1 at a temperature of 25° C. and a melting point in the range of 50 to 200° C., and wherein compound D is used to produce the polyetheresters in an amount of 0 to 5 mol %, based on the number of moles of the ingredient used (a1), comprising at least three groups capable of yielding P1 polyetheresters, as well as other biodegradable polymers and thermoplastic materials for producing biodegradable moulded articles, such as adhesives, biodegradable moulded articles, foams and blends with starch prepared from said polymers or moulding materials.

A method for producing a solid polyurethane composite containing biomass according to the invention, which is formed of a polyurethane layer prepared from oligomers, polyisocyanates, extenders, catalysts. The method for producing a solid polyurethane composite containing biomass is characterised in that a layer of biomass-containing polyurethane is applied onto a support, wherein the applied layer of biomass-containing polyurethane has a thickness of 50 μm to 300 μm, then this is dried in a drying chamber at a temperature of up to 80° C. to 150° C. for 1 to 180 min, and a subsequent layer of biomass-containing polyurethane with a thickness of 300 to 1500 μm is applied onto the dried layer of biomass-containing polyurethane onto which a surface material is applied, and then this is rolled on rolls, followed by baking in a baking chamber at a temperature of 80° C. to 150° C. for 1 to 180 minutes, after which the support is separated. A subsequent polyurethane layer contains biomass. The biomass is a biomass derived from citrus fruit following juice extraction. The biomass derived from citrus fruit following juice extraction consists of 0.01 to 99.99% peel, 0.01 to 99.99% pulp of oranges, mandarins, limes, lemons. The polyurethane containing the biomass and fed onto a support is prepared by mixing 1 to 99 parts by weight of petrochemical oligomerols, 1 to 99 biological oligomerols, 0.01 to 10 parts by weight of catalysts, 0.1 to 20 parts by weight of surfactants, 1 to 90 parts by weight of a isocyanate agent, and 0.01 to 90 parts by weight of crushed biomass, the biomass being citrus fruit biomass following juice extraction. A biological oligomerol is prepared by chemical liquefaction of citrus fruit biomass. The chemical liquefaction process of citrus fruit biomass is conducted at a temperature of 50° C. to 250° C., for a time period of 1 min to 300 mins, at a pressure of 1000 Pa to 150000 Pa and a biomass content of 1% to 90%. The citrus fruit biomass is prepared by drying pulp and peel for a period of 4 to 8 h at a temperature of 90° C. to 100° C., then crushing the dried biomass into grains having 50 μm to 600 μm in size, then drying the biomass grains for a period of 2 hours at a temperature of 90° C. to 100° C. and fractionating these into grains ranging having 60 to 150 μm, 160 to 240 μm, 250 to 360 μm, 370 to 600 μm in size. The support is silicon paper or Teflon paper or a plaster mould or a Teflon mould. The catalyst used is a solution of potassium acetate in ethylene glycol, 1,3,5-tris[3-(dimethylamino)propyl]hexahydro-1,3,5-triazine, 2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof. Polysiloxanes or silicone oils or silicone-glycol copolymer are used as surfactants. Petrochemical oligomerols with a hydroxyl number of 30 to 700 mg KOH/g, an acid number of 0.1 to 10 mg KOH/g, a molecular weight of 100 to 6000 g/mol, and a functionality of 0.5 to 6 are used as petrochemical oligomerols.

The solid polyurethane composite containing biomass according to the invention prepared by the method and formed from polyurethane layers. The solid polyurethane composite containing biomass is characterised in that the polyurethane layers are stacked one on another and have a thickness of 50 to 1500 μm, wherein each polyurethane layer as polyols contains bio-polyols of plant origin with a molecular weight of 100-6000 g/mol, a functionality of 1 to 4 and a hydroxyl number from 30 to 600 mg KOH/g, and one surface of the combined polyurethane layers is coated with a surface material, while one of the polyurethane layers contains 1 to 90% citrus fruit biomass in crushed form. Each polyurethane layer comprises 1 to 90% citrus fruit biomass in crushed form, wherein preferably the first layer has 1 to 20%, and the subsequent layer 50 to 70% biomass. The second surface of the combined polyurethane layers has the texture of citrus fruit, preferably orange peel. Plant origin bio-polyols are prepared from citrus fruit biomass with a molecular weight of 100 to 3000 g/mol, a functionality of 1 to 5, and a hydroxyl number of 100 to 600 mgKOH/g. Citrus fruit biomass is a residue remaining after the extraction of citrus fruit juice and is in the form of grains or powder. Biomass grains range from 50 to 600 μm in size. The texture of the combined layers has a form of orange peel. The surface material is a non-woven or woven fabric. The use of the solid polyurethane composite according to the invention is characterised in that the solid polyurethane composite is used as a material for the manufacture of haberdashery products, in particular handbags, as well as a material for manufacturing wallets, belts as well as coverings for mattresses, armchairs, car seats and sofas;

A method for producing a foamed polyurethane composite containing biomass according to the invention, formed of a polyurethane layer prepared from oligomers, polyisocyanates, extenders, catalysts. The method for producing a foamed polyurethane composite containing biomass is characterised in that a layer of biomass-containing polyurethane is applied onto a support, wherein the applied layer of biomass-containing polyurethane has a thickness of 50 μm to 450 μm, followed by foaming in a foaming chamber and drying in a drying chamber at a temperature of up to 80° C. to 100° C. for 20 to 180 mins, and a subsequent layer of biomass-containing polyurethane with a thickness of 300 μm to 1500 μm is applied onto the dried layer of biomass-containing polyurethane onto which a surface material is applied, and then this is rolled on rolls, followed by baking in a baking chamber at a temperature of 80° C. to 150° C. for 1 to 180 minutes, after which the support is separated. A subsequent polyurethane layer contains biomass. The biomass is a biomass derived from citrus fruit following juice extraction. The biomass is a biomass derived from citrus fruit following juice extraction. The biomass derived from citrus fruit following juice extraction consists of 0.01 to 99.99% peel, 0.01 to 99.99% pulp of oranges, mandarins, limes, lemons. The polyurethane containing the biomass and fed onto a support is prepared by mixing 1 to 99 parts by weight of petrochemical oligomerols, 1 to 99 biological oligomerols, 0.01 to 10 parts by weight of catalysts, 0.1-20 parts by weight of surfactants, and 1 to 20 parts by weight of an eco-friendly foaming agent in the form of hydrocarbon fraction and water, 1 to 90 parts by weight of a isocyanate agent, and 0.01 to 90 parts by weight of ground biomass, the biomass being citrus fruit biomass following juice extraction. Petrochemical oligomerols with a hydroxyl number of 30 to 700 mg KOH/g, an acid number of 0.1 to 10 mg KOH/g, a molecular weight of 100 to 6000 g/mol, and a functionality of 0.5 to 6 are used as petrochemical oligomerols. The isocyanate agent used is an isocyanate agent with a concentration of unbound isocyanate groups of 5% to 48% and a functionality of 0.5 to 4. The isocyanate agent is in the form of a prepolymer with a concentration of unbound isocyanate groups of 2% to 30% and a functionality of 0.5 to 4. The prepolymer used is preferably a prepolymer prepared by way of synthesis of oligomerols with a molecular weight of 90 to 4000 g/mol and isocyanates with a concentration of unbound isocyanate groups of 5 to 48% NCO and loaded with up to 90% parts by weight of citrus fruit biomass. A biological oligomerol is prepared by chemical liquefaction of citrus fruit biomass. The chemical liquefaction process of citrus fruit biomass is conducted at a temperature of 50° C. to 250° C., for a time period of 1 min to 300 mins, at a pressure of 1000 Pa to 150000 Pa and a biomass content of 1% to 90%. The citrus fruit biomass is prepared by drying pulp and peel for a period of 4 to 8 h at a temperature of 90° C. to 100° C., then crushing the dried biomass into grains having 50 μm to 600 μm in size, then drying the biomass grains for a period of 2 hours at a temperature of 90° C. to 100° C. and fractionating these into grains ranging having 60 to 150 μm, 160 to 240 μm, 250 to 360 μm, 370 to 600 μm in size. The support is a silicon paper or a plaster mould or a Teflon mould. The catalyst used is a solution of potassium acetate in ethylene glycol, 1,3,5-tris[3-(dimethylamino)propyl]hexahydro-1,3,5-triazine, 2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof. Polysiloxanes, silicone oils, silicone-glycol copolymer are used as surfactants. The isocyanate agent used is 4,4-diphenylmethane diisocyanate (MDI), 2,4-diisocyanatoluene (TDI), hexamethylene 1,6-diisocyanate (HDI), polymeric 4,4-diphenylmethane diisocyanate (pMDI) or prepolymers with a content of unbound isocyanate groups of 2 to 30%.

The foamed polyurethane composite containing biomass according to the invention prepared by the method and formed from polyurethane layers. The foam polyurethane composite containing biomass is characterised in that the polyurethane layers are stacked one on another and have a thickness of 50 μm to 3500 μm, wherein the first polyurethane layer is foamed, and each polyurethane layer as polyols contains bio-polyols of plant origin with a molecular weight of 100-6000 g/mol, a functionality of 1 to 4 and a hydroxyl number from 30 to 600 mg KOH/g, and one surface of the combined polyurethane layers is coated with a surface material, while one of the polyurethane layers contains 1 to 90% citrus fruit biomass in crushed form. Each polyurethane layer comprises 1 to 90% citrus fruit biomass in crushed form, wherein preferably the first layer has 1 to 20%, and the subsequent layer 50 to 70% biomass. The second surface of the combined polyurethane layers has the texture of citrus fruit, preferably orange peel. Plant origin bio-polyols are prepared from citrus biomass with a molecular weight of 100 to 3000 g/mol, a functionality of 1 to 5, and a hydroxyl number of 100 to 600 mgKOH/g. Citrus biomass is a residue remaining after the extraction of citrus fruit juice and is in the form of grains or powder. Biomass grains have a size range of 60 to 150 μm, 160 to 240 μm, 250 to 360 μm, 370 to 600 μm. The surface material is a non-woven or woven fabric. The use of the foamed polyurethane composite according to the invention is characterised in that the solid polyurethane composite is used as a material for the manufacture of haberdashery products, in particular handbags, as well as a material for manufacturing wallets, belts as well as coverings for mattresses, armchairs, car seats and sofas;

A variation of the method for producing a solid polyurethane composite containing biomass according to the invention, formed of a polyurethane layer prepared from oligomers, polyisocyanates, extenders, catalysts. A variation of the production method is characterised in that a first polyurethane layer containing citrus fruit biomass is applied onto the support, wherein the applied layer of polyurethane containing biomass has a thickness of 50 μm to 300 μm, followed by a second layer of polyurethane containing citrus fruit biomass being applied onto the first layer of polyurethane containing citrus fruit biomass, wherein the second applied layer of polyurethane containing biomass has a thickness of 50 μm to 1500 μm, after which the two layers are pressed together and then dried in a drying chamber at 80° C. to 100° C. for 1 to 180 minutes, and a subsequent layer of the biomass-containing polyurethane is applied, wherein the subsequent applied layer of the biomass-containing polyurethane has a thickness of 50 μm to 1500 μm, and a surface material is applied thereon, followed by rolling all the layers on rolls, and after rolling they are baked in a baking chamber at 80° C. to 150° C. for 1 to 180 minutes, after which the support is separated. The biomass is a biomass derived from citrus fruit following juice extraction. The biomass derived from citrus fruit following juice extraction consists of 0.01 to 99.99% peel, 0.01 to 99.99% pulp of oranges, mandarins, limes, lemons. A polyurethane containing biomass and fed onto a support as first and third layers is prepared by mixing 1 to 99 parts by weight of petrochemical oligomerols, 1 to 99 biological oligomerols, 0.01 to 10 parts by weight of catalysts, 0.1-20 parts by weight of surfactants, and 1 to 90 parts by weight of a isocyanate agent, and 0.01 to 90 parts by weight of ground biomass, the biomass being citrus fruit biomass following juice extraction. A polyurethane containing biomass and fed onto a support as a second layer is prepared by synthesizing a prepolymer with an isocyanine group, followed by mixing with catalysts, citrus fruit biomass and an extender to form a layer with a thickness of 50 μm to 1500 μm thick, which is dried for 1 to 180 minutes at 80° C. to 150° C., followed by the gelled polyurethane being mixed with citrus fruit biomass in the form of grain or powder. The citrus fruit biomass in the second polyurethane layer represents 1 to 90%. The citrus fruit biomass is prepared by drying pulp and peel for a period of 4 to 8 h at a temperature of 90° C. to 100° C., then crushing the dried biomass into grains having 50 μm to 600 μm in size, then drying the biomass grains for a period of 2 hours at a temperature of 90° C. to 100° C. and fractionating these into grains ranging having 60 to 150 μm, 160 to 240 μm, 250 to 360 μm, 370 to 600 μm in size. The biological/natural oligomerol is prepared in the process of chemical liquefaction of citrus biomass with a hydroxyl number of 30 to 800 mg KOH/g, an acid number of 0.1 to 20 mg KOH/g, a molecular weight of 30 g/mol to 7000 g/mol, and a functionality of 1 to 4. The chemical liquefaction process of citrus biomass is conducted at a temperature of 50° C. to 250° C., for a time period of 1 to 300 mins, at a pressure of 1000 Pa to 150000 Pa and a biomass content of 1% to 90%. The support is silicon paper or Teflon paper or a plaster mould or a Teflon mould. The production method according to claim 50, characterised in that the catalyst used is a solution of potassium acetate in ethylene glycol, 1,3,5-tris[3-(dimethylamino)propyl]hexahydro-1,3,5-triazine, 2-[2-(dimethylamino)ethoxy]ethanol, Dabco 33 LV (solution of 1,4-diazabicyclo[2.2.2] octane in ethylene glycol), stannous 2-ethylhexanoate, N,N-dimethylcyclohexylamine (DMCHA), dilaurate or mixtures thereof. Polysiloxanes, silicone oils, silicone-glycol copolymer are used as surfactants;

A variation of a solid polyurethane composite containing biomass according to the invention, prepared by the method and formed with polyurethane layers is characterised in that the polyurethane layers (27, 29, 30) are stacked on top of each other and have a thickness of 50 μm to 3500 μm, wherein each polyurethane layer (27, 29, 30) contains as polyols plant origin bio-polyols with a molecular weight of 100 to 6000 g/mol, a functionality of 1 to 4 and a hydroxyl number of 30 to 600 mg KOH/g, while the middle polyurethane layer (27) contains 1 to 90% citrus fruit biomass in crushed form, preferably 50 to 70%, and one surface of the combined polyurethane layers (27, 29, 30) is coated with the surface material (20). The first polyurethane layer (29) comprises 1 to 90% citrus fruit biomass in crushed form, preferably 1 to 20%. A subsequent polyurethane layer (30) comprises from 1 to 90% citrus biomass in crushed form, preferably 1 to 20%. Plant origin bio-polyols are prepared from citrus fruit biomass with a molecular weight of 100 to 3000 g/mol, a functionality of 1 to 5, and a hydroxyl number of 100 to 600 mgKOH/g. Citrus fruit biomass is a residue remaining after the extraction of citrus fruit juice and is in the form of grains. Biomass grains have a size range of 60 to 150 μm, 160 to 240 μm, 250 to 360 μm, 370 to 600 μm. The outer surface of the combined polyurethane layers has the texture of citrus fruit, preferably orange peel. The surface material is a non-woven or woven fabric. The use of the solid polyurethane composite according to the invention is characterised in that the solid polyurethane composite is used as a material for the manufacture of haberdashery products, in particular handbags, as well as a material for manufacturing wallets, belts as well as coverings for mattresses, armchairs, car seats and sofas.

A variation of the method for producing the foamed polyurethane composite containing biomass according to the invention, formed of a polyurethane layer prepared from oligomers, polyisocyanates, extenders, catalysts. A variation of the production method is characterised in that a first polyurethane layer containing citrus fruit biomass is applied onto the support, wherein the applied layer of polyurethane containing biomass has a thickness of 50 μm to 300 μm, followed by a second layer of polyurethane containing citrus fruit biomass being applied onto the first layer of polyurethane containing citrus fruit biomass, wherein the second applied layer of polyurethane containing biomass has a thickness of 50 μm to 1500 μm, after which the two layers are pressed together, followed by both polyurethane layers being foamed in a foaming chamber and dried in a drying chamber at 80° C. to 100° C. for 1 to 180 minutes, and a subsequent layer of the biomass-containing polyurethane is applied, wherein the subsequent applied layer of the biomass-containing polyurethane has a thickness of 50 μm to 1500 μm, and a surface material is applied thereon, followed by rolling all the layers on rolls, and after rolling they are baked in a baking chamber at 80° C. to 150° C. for 1 to 180 minutes, after which the support is separated. The biomass is a biomass derived from citrus fruit following juice extraction. The biomass derived from citrus fruit following juice extraction consists of 0.01 to 99.99% peel, 0.01 to 99.99% pulp of oranges, mandarins, limes, lemons. A polyurethane containing biomass and fed onto a support as first and third layers is prepared by mixing 1 to 99 parts by weight of petrochemical oligomerols, 1 to 99 biological oligomerols, 0.01 to 10 parts by weight of catalysts, 0.1-20 parts by weight of surfactants, and 1 to 90 parts by weight of a isocyanate agent, and 0.01 to 90 parts by weight of ground biomass, the biomass being citrus fruit biomass following juice extraction. A polyurethane containing biomass and fed onto a support as a second layer is prepared by synthesizing a prepolymer with an isocyanine group, followed by mixing with catalysts, citrus fruit biomass and an extender to form a layer with a thickness of 50 μm to 1500 μm thick, which is dried for 1 to 180 minutes at 80° C. to 150° C., followed by the gelled polyurethane being mixed with citrus fruit biomass in the form of grain or powder. The citrus fruit biomass in the second polyurethane layer represents 1 to 90%. The citrus fruit biomass is prepared by drying pulp and peel for a period of 4 to 8 h at a temperature of 90° C. to 100° C., then crushing the dried biomass into grains having 50 μm to 600 μm in size, then drying the biomass grains for a period of 2 hours at a temperature of 90° C. to 100° C. and fractionating these into grains ranging having 60 to 150 μm, 160 to 240 μm, 250 to 360 μm, 370 to 600 μm in size. The biological oligomerol is prepared in the process of chemical liquefaction of citrus biomass with a hydroxyl number of 30 to 800 mg KOH/g, an acid number of 0.1 to 20 mg KOH/g, a molecular weight of 30 g/mol to 7000 g/mol, and a functionality of 1 to 4. The chemical liquefaction process of citrus biomass is conducted at a temperature of 50° C. to 250° C., for a time period of 1 to 300 mins, at a pressure of 1000 Pa to 150000 Pa and a biomass content of 1% to 90%. The support is silicon paper or Teflon paper or a plaster mould or a Teflon mould. The catalyst used is a solution of potassium acetate in ethylene glycol, 1,3,5-tris[3-(dimethylamino)propyl]hexahydro-1,3,5-triazine, 2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof. Polysiloxanes, silicone oils, silicone-glycol copolymer are used as surfactants.

A variation of a foamed polyurethane composite containing biomass prepared by the method according to the invention and formed with polyurethane layers. A variation of the foamed composite is characterised in that the polyurethane layers are stacked on top of each other and have a thickness of 50 μm to 3500 μm, with two polyurethane layers being foamed, wherein each polyurethane layer contains as polyols bio-polyols of plant origin with a molecular weight of 100 to 6000 g/mol, functionality of 1 to 4 and hydroxyl number of 30 to 600 mg KOH/g, wherein the middle polyurethane layer contains citrus fruit biomass in crushed form, and one surface of the combined polyurethane layers is coated with the surface material. The first polyurethane layer comprises 1 to 90% citrus fruit biomass in crushed form, preferably 1 to 20%. A subsequent polyurethane layer comprises from 1 to 90% citrus biomass in crushed form, preferably 1 to 20%. Citrus fruit biomass is a residue remaining after the extraction of citrus fruit juice and is in the form of grains or powder. Biomass grains have a size range of 60 to 150 μm, 160 to 240 μm, 250 to 360 μm, 370 to 600 μm. The outer surface of the combined polyurethane layers has the texture of citrus fruit, preferably orange peel. The surface material is a non-woven or woven fabric. Each polyurethane layer comprises 1 to 90% citrus fruit biomass in crushed form, wherein preferably the first layer has 1 to 20%, a middle layer from 50 to 70%, and the subsequent layer has 1 to 20% biomass. The use of the foamed polyurethane composite according to the invention is characterised in that the solid polyurethane composite is used as a material for the manufacture of haberdashery products, in particular handbags, as well as a material for manufacturing wallets, belts as well as coverings for mattresses, armchairs, car seats and sofas;

A method for producing a solid polyurethane composite containing biomass and a solid polyurethane composite produced by said method and a method of producing a foamed polyurethane composite containing biomass and a foamed polyurethane composite produced by the method according to the invention is characterised in that the production process is more environmentally friendly. It is also characterised by lower process costs and the possibility of using biomass constituting waste from other processes. The use of citrus biomass as a polymer filler results in converting post-consumer waste and production residues into resources. This was achieved by using a biological oligomer prepared from citrus biomass as a polyol ingredient, and by adding citrus fruit biomass to the polymers. Surprisingly, it was found that the citrus waste additive used for polyurethane modifies the properties of the resulting product. The resulting product is also characterised by enhanced rigidity and hardness, making it suitable for producing utility products such as handbags, bags. Another unexpected effect is a very pleasant smell of the product, so that the products made of this material fill the room with a pleasant fragrance, making it unnecessary for example to use additional air fresheners. The resulting product is resistant to UV radiation, which is absorbed by the citrus fruit biomass, and has superior biodegradability compared to an unfilled polymer. Moreover, the use of citrus fruit biomass in the product makes it easier to obtain the colour of the final product, which increases the possibilities of using the resulting composite, while lowering the cost of producing the final product with the desired colour. The use of citrus fruit biomass in the process of preparing foamed composites allows for reducing the amount of porophores, thus reducing the cost of composite preparation. Surprisingly, it was also found that a foamed polyurethane composite with higher elasticity and a softer texture was obtained, while the product's improved mechanical properties were retained. Moreover, the solid and foamed products obtained have the appearance of citrus fruit texture, e.g. orange peel or lemon peel, which allows a wide range of applications thereof, as they have properties that allow them to be used as textiles or upholstery materials and, in addition, they give off a fragrance.

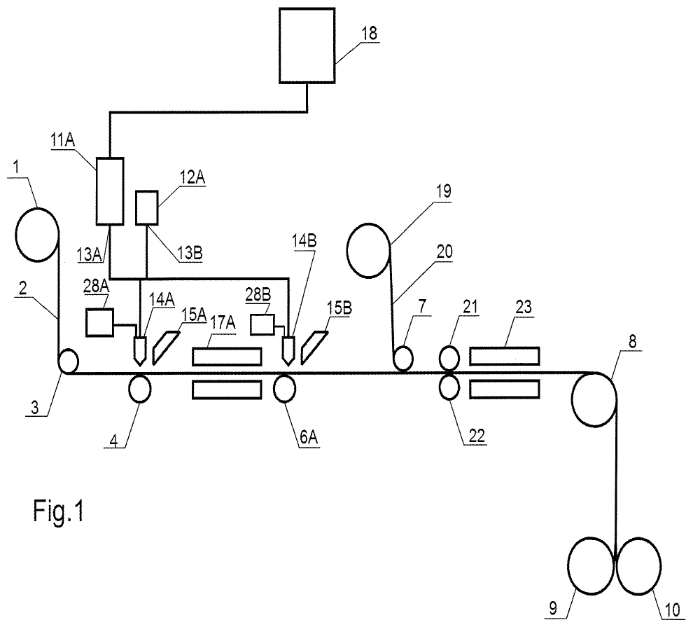

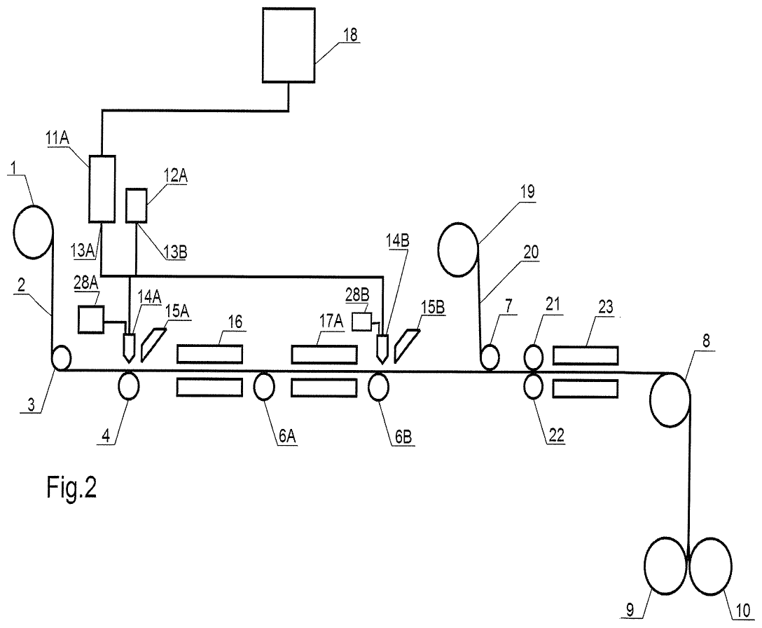

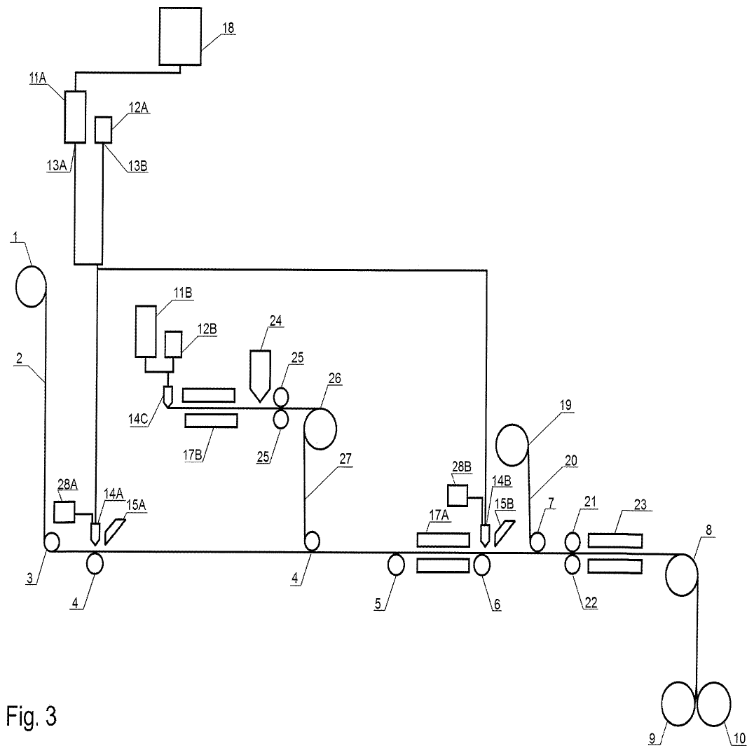

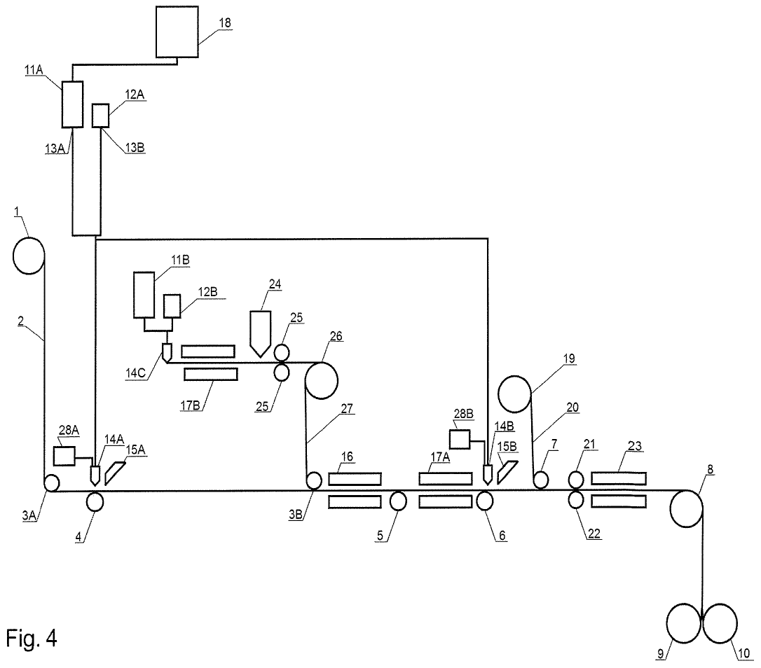

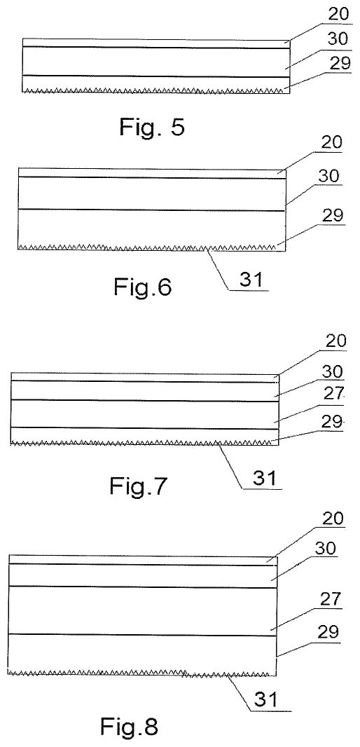

A method for producing a solid polyurethane composite containing biomass and a solid polyurethane composite produced by said method and a method of producing a foamed polyurethane composite containing biomass and a foamed polyurethane composite produced by said method according to the invention, is explained in more detail in the embodiments and in the drawings, where FIG. 1 shows a schematic diagram of a process for producing a solid polyurethane composite, FIG. 2 shows a schematic diagram of a process for producing a foamed polyurethane composite containing biomass, FIG. 3 shows a schematic diagram of a variation of the process for producing a solid polyurethane composite, FIG. 4 shows a schematic diagram of a variation of the process for producing a foamed polyurethane composite containing biomass, FIG. 5 schematically shows the solid composite prepared by the first method, FIG. 6 schematically shows the foamed composite prepared by the first method, FIG. 7 schematically shows the solid composite prepared by the second method, and FIG. 8 schematically shows the foamed composite prepared by the second method.

As shown in FIG. 1, the first method for producing a solid polyurethane composite containing biomass involves unwinding a support 2 in the form of a silicon paper which has a texture 31 of citrus fruit, preferably resembling orange peel, from the roll 1. The support 2 is then passed through successive rolls 3A, 4, 3B, 5, 6 and 8. A polyurethane layer with a thickness of 50 μm is then applied onto the support 2 using the mixing and dispensing head 14A. Polyurethane is prepared by synthesising the prepolymer in the reactor 18 with NCO isocyanate groups and OH hydroxyl groups. The prepolymer is then fed from the reactor 18 into the tank 11A and dispensed via the dispensing pump 13A into the mixing and dispensing head 14A, where the prepolymer is mixed with substrates in the form of catalyst, citrus fruit biomass and chain extender, which are fed from the mixer 12A by the dispensing pump 13B and biomass from the biomass dispenser 28A. The resulting polyurethane with biomass is fed through the mixing and dispensing head 14A onto the support 2. The thickness of the polyurethane layer 29 is adjusted using a thickness adjuster 15A in the form of a knife. The polyurethane layer 29 on the support 2 is then dried in the drying chamber 17A, and when dried, a subsequent polyurethane layer 30 with a thickness of 300 μm or more is applied using the mixing and dispensing head 14B. Polyurethane is prepared by synthesising the prepolymer in the reactor 18 with NCO isocyanate groups. The prepolymer is then fed from the reactor 18 into the tank 11A and dispensed by the dispensing pump 13A into the mixing and dispensing head 14B where the prepolymer is mixed with substrates in the form of catalyst, citrus fruit biomass and chain extender, which are fed from the mixer 12B using the dispensing pump 13B. The thickness of the polyurethane layer 30 is adjusted using a thickness adjuster 15B. Citrus fruit biomass may be added to the polymer from the biomass dispenser 28B. Using the carrying roll 7, the surface material 20 from the roll 19 is applied. This is then rolled on rolls 21 and 22 and baked in the baking chamber 23, followed by the article being rolled through the receiving roll 8 and separating the support 2 from the solid composite and winding it onto the roll 9, while the solid composite is wound onto the roll 10. The resulting solid composite is shown in FIG. 5. It is formed with a first polyurethane layer 29 with citrus fruit biomass applied onto a support 2, onto which a subsequent polyurethane layer 30 is applied, which is coated by the surface material 20. The polyurethane layer 30 may additionally contain admixed citrus biomass in a crushed form such as grains or powder. Each polyurethane layer 29, 30 contains 1 to 90% citrus fruit biomass in crushed form. Preferably, the first polyurethane layer 29 with citrus fruit biomass comprises from 1 to 20% biomass, and the subsequent polyurethane layer 30 with citrus fruit biomass comprises from 50 to 70%. On one surface of the combined polyurethane layers 29, 30, the solid composite has the texture 31 of a citrus fruit, preferably orange peel. Polyurethane layers 29,30 stacked on top of each other have a thickness of 50 to 1500 μm.

A variation of the method for producing a solid polyurethane composite containing biomass as shown in the schematic diagram in FIG. 3 involves applying a second polyurethane layer 27 with citrus fruit biomass having a thickness of 50 μm onto the first polyurethane layer 29 containing citrus fruit biomass, which is applied onto the support 2 prior to drying in the drying chamber 17A. A second polyurethane layer 27 with citrus fruit biomass is prepared by dispensing a prepolymer with substrates in the form of a catalyst, citrus fruit biomass and a chain extender to a mixing and dispensing head 14C from the tank 11B, which are fed from the mixer 12B. The polyurethane is then dried in drying chamber 17B and citrus fruit biomass is added from the dispenser 24. Polymer is mixed with citrus fruit biomass by passing the polyurethane with citrus fruit biomass through the rolls 25 several times. The rolls 25 follow a counter-rotating movement, which ensures proper shear force and proper filler dispersion throughout the polymer volume. A second polyurethane layer 27 citrus fruit biomass is then collected and applied onto the first polyurethane layer 29 with citrus fruit biomass using a carrying roll 4. Both polyurethane layers 29,27 with citrus fruit biomass are then dried in the drying chamber 17A, and when dried, a subsequent polyurethane layer 30 with a thickness of 50 μm is applied using the mixing and dispensing head 14B. Polyurethane is prepared by synthesising the prepolymer in the reactor 18 with NCO isocyanate groups. The prepolymer is then fed from the reactor 18 into the tank 11A and dispensed by the dispensing pump 13A into the mixing and dispensing head 14B where the prepolymer is mixed with substrates in the form of catalyst, citrus fruit biomass and chain extender, which are fed from the mixer 12A using the dispensing pump 13B. The thickness of the polyurethane layer 30 is adjusted using a thickness adjuster 15B. Citrus fruit biomass may be added to the polymer from the biomass dispenser 28B. The surface material 20 from the roll 19 is applied using the carrying roll 7 onto the third polymer layer. This is then rolled on rolls 21 and 22 and baked in the baking chamber 23, followed by the article being rolled through the receiving roll 8 and separating the support 2 from the solid composite and winding it onto the roll 9, while the solid composite is wound onto the roll 10. The initial step wherein the first polyurethane layer 29 containing citrus fruit biomass on the support 2 is obtained is conducted as in the first method. A variation of the solid composite produced by this method is shown in FIG. 7. A variation of this solid composite is formed with a first polyurethane layer 29 with citrus fruit biomass applied onto the support 2, which contains citrus fruit biomass in crushed form. The biomass volume may be in a range of 1 to 90%, preferably in a range of 1 to 20%. A middle polyurethane layer 27 with citrus fruit biomass is applied onto it. The amount of biomass may range from 1 to 90% citrus fruit biomass in crushed form, preferably from 50 to 70%. A subsequent polyurethane layer 30, coated by the surface material 20, is applied onto the middle polyurethane layer 27 with citrus fruit biomass. This polyurethane layer 30 may contain citrus fruit biomass in crushed form in an amount of 1 to 90%, preferably 1 to 20%. Polyurethane layers (27, 29, 30) are stacked on top of each other and have a thickness of 50 μm to 3500 μm.

The method for producing a foamed polyurethane composite containing biomass, as shown in the schematic diagram in FIG. 2, involves unwinding a support 2 in the form of a silicon paper which has a texture of citrus fruit, preferably resembling orange peel, from the roll 1. The support 2 is then passed through successive rolls 3A, 4, 3B, 5, 6 and 8. A polyurethane layer 29 with a thickness of 50 μm is then applied onto the support 2 using the mixing and dispensing head 14A. Polyurethane is prepared by synthesising the prepolymer in the reactor 18 with NCO isocyanate groups and OH hydroxyl groups. The prepolymer is then fed from the reactor 18 into the tank 11A and dispensed via the dispensing pump 13A into the mixing and dispensing head 14A, where the prepolymer is mixed with substrates in the form of catalyst, citrus fruit biomass and chain extender, which are fed from the mixer 12A by the dispensing pump 13B and biomass from the biomass dispenser 28A. The resulting polyurethane with citrus fruit biomass is fed through the mixing and dispensing head 14A onto the support 2. The thickness of the polyurethane layer 29 is adjusted using a thickness adjuster 15A in the form of a knife. The polyurethane layer with the biomass on the support 2 is then foamed in the foaming chamber 16 and dried in the drying chamber 17A at a temperature of 80° C. for 10 minutes. After drying, a subsequent polyurethane layer 30 with a thickness of 300 μm is applied using a mixing and dispensing head 14B. Polyurethane is prepared by synthesising the prepolymer in the reactor 18 with NCO isocyanate groups. The prepolymer is then fed from the reactor 18 into the tank 11A and dispensed by the dispensing pump 13A into the mixing and dispensing head 14B where the prepolymer is mixed with substrates in the form of catalyst, citrus fruit biomass and chain extender, which are fed from the mixer 12A using the dispensing pump 13B. The thickness of the polyurethane layer is adjusted using a thickness adjuster 15B. Citrus fruit biomass may be added to the polymer from the biomass dispenser 28B. The applied polyurethane layer 30 containing citrus fruit biomass has a thickness of 50 μm. Using the carrying roll 7, the surface material 20 from the roll 19 is applied. This is then rolled on the rolls 21 and 22 and baked in the baking chamber 23 at a temperature of 80° C. for 5 minutes. The article is then passed through the receiving roll 8 and the support 2 is separated from the foamed composite and wound onto the roll 9, while the foamed composite is wound onto the roll 10. The foamed composite produced by this method is shown in FIG. 6. It is formed with a first polyurethane layer 29 with citrus fruit biomass applied onto the support 2, wherein the polyurethane layer 29 is foamed, and a subsequent polyurethane layer 30 coated by the surface material 20. Polyurethane layers (29, 30) are stacked on top of each other and have a thickness of 50 μm to 3500 μm. One surface of the combined polyurethane layers (29, 30) is coated by a surface material (20). The polyurethane layers (29, 30) contain 1 to 90% citrus biomass in crushed form. Each polyurethane layer (29, 30) comprises 1 to 90% citrus fruit biomass in crushed form, wherein preferably the first layer (29) has 1 to 20%, and the subsequent layer (30) 50 to 70% biomass. The outer surface of the combined polyurethane layers (29,30) has a texture (31) of citrus fruit, preferably resembling orange peel.

A variation of the method for producing a foamed polyurethane composite containing biomass as shown in the schematic diagram in FIG. 4 involves applying a second polyurethane layer 27 with citrus fruit biomass having a thickness of 50 μm onto the first polyurethane layer 29 containing citrus fruit biomass, which is applied onto the support 2 prior to drying in the drying chamber 17A. The second polyurethane layer 27 with citrus fruit biomass is prepared by dispensing a prepolymer with substrates in the form of a catalyst, citrus fruit biomass and a chain extender to a mixing and dispensing head 14C from the tank 11B, which are fed from the mixer 12B. The polyurethane is then dried in drying chamber 17B and citrus fruit biomass is added from the dispenser 24. The polymer is mixed with citrus fruit biomass by passing the polyurethane with citrus fruit biomass through the rolls 25 several times. The rolls 25 follow a counter-rotating movement, which ensures proper shear force and proper biomass dispersion throughout the polymer volume. A second polyurethane layer 27 citrus fruit biomass is then collected and applied onto the first polyurethane layer 29 with citrus fruit biomass using a carrying roll 3B. The polyurethane layers (29, 27) with citrus fruit biomass on the support 2 are then foamed in the foaming chamber 16 and dried in the drying chamber 17A at a temperature of 80° C. for 10 minutes. After drying, a subsequent polyurethane layer (30) with a thickness of 300 μm is applied using a mixing and dispensing head 14B. Polyurethane is prepared by synthesising the prepolymer in the reactor 18 with NCO isocyanate groups. The prepolymer is then fed from the reactor 18 into the tank 11A and dispensed by the dispensing pump 13A into the mixing and dispensing head 14B where the prepolymer is mixed with substrates in the form of catalyst, citrus fruit biomass and chain extender, which are fed from the mixer 12A using the dispensing pump 13B. The thickness of the polyurethane layer 30 is adjusted using a thickness adjuster 15B. Biomass from citrus fruit biomass dispenser 28B may be added to the polymer. The applied polyurethane layer containing citrus fruit biomass has a thickness of 50 μm. Using the carrying roll 7, the surface material 20 from the roll 19 is applied. This is then rolled on the rolls 21 and 22 and baked in the baking chamber 23 at a temperature of 80° C. for 5 minutes. The article is then passed through the receiving roll 8 and the support 2 is separated from the foamed composite and wound onto the roll 9, while the foamed composite is wound onto the roll 10. A variation of the foamed composite produced by this method is shown in FIG. 8. A variation of this foamed composite is formed with a first polyurethane layer 29 with citrus fruit biomass applied onto the support 2, a middle polyurethane layer 27 with citrus fruit biomass, wherein both layers 27,29 are foamed, and a subsequent polyurethane layer 30 coated by the surface material 20. Polyurethane layers (27, 29, 30) are stacked on top of each other and have a thickness of 50 μm to 3500 μm. The first polyurethane layer (29) comprises 1 to 90% citrus fruit biomass in crushed form, preferably 1 to 20%. The middle polyurethane layer (27) comprises 1 to 90% citrus fruit biomass in crushed form, preferably 50 to 70%. A subsequent polyurethane layer (30) comprises from 1 to 90% citrus biomass in crushed form, preferably 1 to 20%. The outer surface of the combined polyurethane layers (27,29,30) has a texture (31) of citrus fruit, preferably resembling orange peel. The surface material (20), in turn, is a non-woven or woven fabric;

Silicon paper or Teflon paper or plaster mould or Teflon mould is used as the support 2 for the poured polymers.

The fruit citrus biomass added to the polyurethane layers is prepared by drying pulp and peel for a period of time from 4 to 8 h at a temperature of 900° C. or more, followed by crushing the dried fruit citrus biomass into grains with a size of 50 μm or larger. The biomass grains are then dried for 2 hours at a temperature of 900° C. or more and fractionated into grains of 60 to 150 μm, 160 to 240 μm, 250 to 360 μm, 370 to 600 μm or more in size. The biomass derived from citrus fruit following juice extraction consists of 0.01 to 99.99% peel, 0.01 to 99.99% pulp of oranges, mandarins, limes, lemons.

Examples preparation of solid and foamed composites

### Example 1

The solid polyurethane composite was prepared as follows. To 100 g of prepolymer prepared using PTMG 2000 and MDI diisocyanate with a concentration of unbound NCO groups of 8%, biomass with a grain size of 60 to 150 μm was added at a amount of 0.01 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 80° C. for 1 min. A second layer with a thickness of 300 μm was then applied onto the resulting/obtained thin layer. The second layer was prepared by mixing 100 g of prepolymer with 0.01 g of biomass with a grain size of 60-150 μm and 8.57 g of 1,4-butanadiol. This was then placed in an incubator for 1 min at a temperature of 80° C. The resulting composite was then separated from the paper. A polyurethane composite with a thickness of 350 μm and a tensile strength of 12 MPa was obtained.

### Example 2

The solid polyurethane composite was prepared as follows. To 100 g of prepolymer prepared using PTMG 2000 and MDI diisocyanate with a concentration of unbound NCO groups of 8%, biomass with a grain size of 160 to 240 μm was added at a amount of 30 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 80° C. for 1 min. A second layer with a thickness of 300 μm was then applied onto the resulting/obtained thin layer. The second layer was prepared by mixing 100 g of prepolymer with 30 g of biomass with a grain size of 160-240 μm and 8.57 g of 1,4-butanadiol. This was then placed in an incubator for 5 min at a temperature of 100° C. The resulting composite was then separated from the paper. A polyurethane composite with a thickness of 350 μm and a tensile strength of 11.5 MPa was obtained.

### Example 3

The solid polyurethane composite was prepared as follows. To 100 g of prepolymer prepared using PTMG 2000 and MDI diisocyanate with a concentration of unbound NCO groups of 8%, biomass with a grain size of 350 to 360 μm was added at a amount of 90 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 105° C. for 15 min. A second layer with a thickness of 300 μm was then applied onto the resulting/obtained thin layer. The second layer was prepared by mixing 100 g of prepolymer with 90 g of biomass with a grain size of 160-240 μm and 8.57 g of 1,4-butanadiol. This was then placed in an incubator for 15 mins at a temperature of 105° C. The resulting composite was then separated from the paper. A polyurethane composite with a thickness of 350 μm and a tensile strength of 11.5 MPa was obtained.

### Example 4

The solid polyurethane composite was prepared as follows. To 100 g of prepolymer prepared using PTMG 2000 and MDI diisocyanate with a concentration of unbound NCO groups of 8%, biomass with a grain size of 60 to 150 μm was added at a amount of 0.01 g and stirred for 5 mins. 8.57 g of 1,4-butanediol was then added and stirred for 10 s, followed by pouring this onto a textured paper to obtain a 150 μm thick layer using an applicator. This was then heated in an incubator at a temperature of 80° C. for 1 min. A second layer with a thickness of 800 μm was then applied onto the resulting/obtained thin layer. The second layer was prepared by mixing 100 g of prepolymer with 0.01 g of biomass with a grain size of 160-240 μm and 8.57 g of 1,4-butanadiol. This was then placed in an incubator for 1 min at a temperature of 105° C. The resulting composite was then separated from the paper. A polyurethane composite with a thickness of 950 μm and a tensile strength of 12.3 MPa was obtained.

### Example 5

The solid polyurethane composite was prepared as follows. To 100 g of prepolymer prepared using PTMG 2000 and MDI diisocyanate with a concentration of unbound NCO groups of 8%, biomass with a grain size of 160 to 240 μm was added at a amount of 45 g and stirred for 5 mins. 8.57 g of 1,4-butanediol was then added and stirred for 10 s, followed by pouring this onto a textured paper to obtain a 150 μm thick layer using an applicator. This was then heated in an incubator at a temperature of 110° C. for 100 min. A second layer with a thickness of 800 μm was then applied onto the resulting/obtained thin layer. The second layer was prepared by mixing 100 g of prepolymer with 45 g of biomass with a grain size of 160-240 μm and 8.57 g of 1,4-butanadiol. This was then placed in an incubator for 110 min at a temperature of 100° C. The resulting composite was then separated from the paper. A polyurethane composite with a thickness of 950 μm and a tensile strength of 11.3 MPa was obtained.

### Example 6

The solid polyurethane composite was prepared as follows. To 100 g of prepolymer prepared using PTMG 2000 and MDI diisocyanate with a concentration of unbound NCO groups of 8%, biomass with a grain size of 160 to 240 μm was added at a amount of 90 g and stirred for 5 mins. 8.57 g of 1,4-butanediol was then added and stirred for 10 s, followed by pouring this onto a textured paper to obtain a 150 μm thick layer using an applicator. This was then heated in an incubator at a temperature of 110° C. for 60 min. A second layer with a thickness of 800 μm was then applied onto the resulting/obtained thin layer. The second layer was prepared by mixing 100 g of prepolymer with 90 g of biomass with a grain size of 160-240 μm and 8.57 g of 1,4-butanadiol. This was then placed in an incubator for 60 min at a temperature of 110° C. The resulting composite was then separated from the paper. A polyurethane composite with a thickness of 950 μm and a tensile strength of 9.3 MPa was obtained.

### Example 7

The solid polyurethane composite was prepared as follows. To 100 g of prepolymer prepared using PTMG 2000 and MDI diisocyanate with a concentration of unbound NCO groups of 8%, biomass with a grain size of 360 to 600 μm was added at a amount of 0.01 g and stirred for 5 mins. 8.57 g of 1,4-butanediol was then added and stirred for 10 s, followed by pouring this onto a textured paper to obtain a 300 μm thick layer using an applicator. This was then heated in an incubator at a temperature of 150° C. for 180 min. A second layer with a thickness of 1500 μm was then applied onto the resulting/obtained thin layer. The second layer was prepared by mixing 100 g of prepolymer with 0.01 g of biomass with a grain size of 360-600 μm and 8.57 g of 1,4-butanadiol. This was then placed in an incubator for 180 min at a temperature of 150° C. The resulting composite was then separated from the paper. A polyurethane composite with a thickness of 1850 μm and a tensile strength of 15 MPa was obtained.

### Example 8

The solid polyurethane composite was prepared as follows. To 100 g of prepolymer prepared using PTMG 2000 and MDI diisocyanate with a concentration of unbound NCO groups of 8%, biomass with a grain size of 250 to 360 μm was added at a amount of 45 g and stirred for 5 mins. 8.57 g of 1,4-butanediol was then added and stirred for 10 s, followed by pouring this onto a textured paper to obtain a 300 μm thick layer using an applicator. This was then heated in an incubator at a temperature of 120° C. for 120 mins. A second layer with a thickness of 1500 μm was then applied onto the resulting/obtained thin layer. The second layer was prepared by mixing 100 g of prepolymer with 45 g of biomass with a grain size of 250-360 μm and 8.57 g of 1,4-butanadiol. This was then placed in an incubator for 120 mins at a temperature of 120° C. The resulting composite was then separated from the paper. A polyurethane composite with a thickness of 1850 μm and a tensile strength of 13 MPa was obtained.

### Example 10

The solid polyurethane composite was prepared as follows. To 100 g of prepolymer prepared using PTMG 2000 and MDI diisocyanate with a concentration of unbound NCO groups of 8%, biomass with a grain size of 160 to 240 μm was added at a amount of 90 g and stirred for 5 mins. 8.57 g of 1,4-butanediol was then added and stirred for 10 s, followed by pouring this onto a textured paper to obtain a 300 μm thick layer using an applicator. This was then heated in an incubator at a temperature of 90° C. for 30 mins. A second layer with a thickness of 1500 μm was then applied onto the resulting/obtained thin layer. The second layer was prepared by mixing 100 g of prepolymer with 90 g of biomass with a grain size of 160-240 μm and 8.57 g of 1,4-butanadiol. This was then placed in an incubator for 10 mins at a temperature of 90° C. The resulting composite was then separated from the paper. A polyurethane composite with a thickness of 1850 μm and a tensile strength of 9.0 MPa was obtained.

### Example 11

The solid polyurethane composite was prepared as follows. To 100 g of prepolymer prepared using PTMG 2000 and MDI diisocyanate with a concentration of unbound NCO groups of 8%, biomass with a grain size of 250 to 360 μm was added at a amount of 30 g and stirred for 5 mins. 8.57 g of 1,4-butanediol was then added and stirred for 10 s, followed by pouring this onto a textured paper to obtain a 150 μm thick layer using an applicator. This was then heated in an incubator at a temperature of 110° C. for 60 mins. A second layer with a thickness of 1500 μm was then applied onto the resulting/obtained thin layer. The second layer was prepared by mixing 100 g of prepolymer with 0.1 g of biomass with a grain size of 250-360 μm and 8.57 g of 1,4-butanadiol. This was then placed in an incubator for 60 min at a temperature of 110° C. The resulting composite was then separated from the paper. A polyurethane composite with a thickness of 1650 μm and a tensile strength of 13.1 MPa was obtained.

### Example 12

The solid polyurethane composite was prepared as follows. To 100 g of prepolymer prepared using PTMG 2000 and MDI diisocyanate with a concentration of unbound NCO groups of 8%, biomass with a grain size of 250 to 360 μm was added at a amount of 90 g and stirred for 5 mins. 8.57 g of 1,4-butanediol was then added and stirred for 10 s, followed by pouring this onto a textured paper to obtain a 150 μm thick layer using an applicator. This was then heated in an incubator at a temperature of 110° C. for 110 mins. A second layer with a thickness of 750 μm was then applied onto the resulting/obtained thin layer. The second layer was prepared by mixing 100 g of prepolymer with 0.01 g of biomass with a grain size of 250-360 μm and 8.57 g of 1,4-butanadiol. This was then placed in an incubator for 60 min at a temperature of 110° C. The resulting composite was then separated from the paper. A polyurethane composite with a thickness of 900 μm and a tensile strength of 13.5 MPa was obtained.

### Example 13

The solid polyurethane composite was prepared as follows. To 100 g of prepolymer prepared using PTMG 2000 and MDI diisocyanate with a concentration of unbound NCO groups of 8%, biomass with a grain size of 250 to 360 μm was added at a amount of 90 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 110° C. for 60 mins. A second layer with a thickness of 1500 μm was then applied onto the resulting/obtained thin layer. The second layer was prepared by mixing 100 g of prepolymer with 90 g of biomass with a grain size of 250-360 μm and 8.57 g of 1,4-butanadiol. This was then placed in an incubator for 60 min at a temperature of 110° C. The resulting composite was then separated from the paper. A polyurethane composite with a thickness of 1550 μm and a tensile strength of 9.8 MPa was obtained.

### Example 14

The solid polyurethane composite was prepared as follows. To 100 g of prepolymer prepared using PTMG 2000 and MDI diisocyanate with a concentration of unbound NCO groups of 8%, biomass with a grain size of 250 to 360 μm was added at a amount of 20 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 110° C. for 60 mins. A second layer with a thickness of 1500 μm was then applied onto the resulting/obtained thin layer. The second layer was prepared by mixing 100 g of prepolymer with 50 g of biomass with a grain size of 250-360 μm and 8.57 g of 1,4-butanadiol. This was then placed in an incubator for 60 min at a temperature of 110° C. The resulting composite was then separated from the paper. A polyurethane composite with a thickness of 1550 μm and a tensile strength of 11.8 MPa was obtained.

### Example 15

The solid polyurethane composite was prepared as follows. To 100 g of prepolymer prepared using PTMG 2000 and MDI diisocyanate with a concentration of unbound NCO groups of 8%, biomass with a grain size of 150 to 240 μm was added at a amount of 25 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 110° C. for 60 mins. A second layer with a thickness of 1500 μm was then applied onto the resulting/obtained thin layer. The second layer was prepared by mixing 100 g of prepolymer with 70 g of biomass with a grain size of 160-250 μm and 8.57 g of 1,4-butanadiol. This was then placed in an incubator for 60 min at a temperature of 110° C. The resulting composite was then separated from the paper. A polyurethane composite with a thickness of 1550 μm and a tensile strength of 10.8 MPa was obtained.

### Example 16

The solid polyurethane composite was prepared as follows. To 100 g of prepolymer prepared using PTMG 2000 and MDI diisocyanate with a concentration of unbound NCO groups of 8%, biomass with a grain size of 50 to 150 μm was added at a amount of 15 g and stirred for 5 mins. 8.57 g of 1,4-butanediol was then added and stirred for 10 s, followed by pouring this onto a textured paper to obtain a 50 μm thick layer using an applicator. This was then heated in an incubator at a temperature of 110° C. for 60 mins. A second layer with a thickness of 1500 μm was then applied onto the resulting/obtained thin layer. The second layer was prepared by mixing 100 g of prepolymer with 75 g of biomass with a grain size of 250-360 μm and 8.57 g of 1,4-butanadiol. This was then placed in an incubator for 60 min at a temperature of 110° C. The resulting composite was then separated from the paper. A polyurethane composite with a thickness of 1550 μm and a tensile strength of 10.8 MPa was obtained.

### Example 17

The foamed polyurethane composite was prepared as follows. 100 g oligomerol with a L_{OH} hydroxyl number of 200 mgKOH/g was mixed with 1.5 g of a 33% potassium acetate solution in ethylene glycol as catalyst, 1.5 g of 1,3,5-tris[3-(dimethylamino)propyl]hexahydro-1,3,5-triazine catalyst, 4 g of polysiloxane surfactant, 10 g of n-pentane porophore, and 20 g of citrus biomass with a grain size of 50 to 150 μm. 42 g diisocyanate (MDI) was then added and stirred for 10 s, followed by pouring this onto a textured paper to obtain a 50 μm thick layer using an applicator. This was then heated in an incubator at a temperature of 80° C. for 5 mins. A second layer with a thickness of 1500 μm was then applied onto the resulting/obtained thin layer. The second layer was prepared by mixing 100 g of prepolymer with 75 g of biomass with a grain size of 150-260 μm and 8.57 g of 1,4-butanadiol. This was then placed in an incubator for 10 min at a temperature of 100° C. The resulting composite was then separated from the paper. A foamed polyurethane composite with a thickness of 1550 μm and a tensile strength of 8.8 MPa was obtained.

### Example 18

The foamed polyurethane composite was prepared as follows. 100 g oligomerol with a L_{OH} hydroxyl number of 240 mgKOH/g was mixed with 1.5 g of a 33% potassium acetate solution in ethylene glycol as catalyst, 2.5 g of 1,3,5-tris[3-(dimethylamino)propyl]hexahydro-1,3,5-triazine catalyst, 3 g of polysiloxane surfactant, 10 g of n-pentane porophore, and 10 g of citrus biomass with a grain size of 160 to 240 μm. 40 g diisocyanate (MDI) was then added and stirred for 10 s, followed by pouring this onto a textured paper to obtain a 100 μm thick layer using an applicator. This was then heated in an incubator at a temperature of 80° C. for 5 mins. A second layer with a thickness of 750 μm was then applied onto the resulting/obtained thin layer. The second layer was prepared by mixing 100 g of prepolymer with 90 g of biomass with a grain size of 150-260 μm and 8.57 g of 1,4-butanadiol. This was then placed in an incubator for 10 min at a temperature of 100° C. The resulting composite was then separated from the paper. A foamed polyurethane composite with a thickness of 850 μm and a tensile strength of 7.8 MPa was obtained.

### Example 19

The foamed polyurethane composite was prepared as follows. 100 g oligomerol with a L_{OH} hydroxyl number of 200 mgKOH/g was mixed with 1.5 g of a 33% potassium acetate solution in ethylene glycol as catalyst, 2.5 g of 1,3,5-tris[3-(dimethylamino)propyl]hexahydro-1,3,5-triazine catalyst, 3 g of polysiloxane surfactant, 5 g of n-pentane porophore, and 1 g of citrus biomass with a grain size of 160 to 240 μm. 40 g diisocyanate (MDI) was then added and stirred for 10 s, followed by pouring this onto a textured paper to obtain a 300 μm thick layer using an applicator. This was then heated in an incubator at a temperature of 100° C. for 100 mins. A second layer with a thickness of 1000 μm was then applied onto the resulting/obtained thin layer. The second layer was prepared by mixing 100 g of prepolymer with 45 g of biomass with a grain size of 150-260 μm and 8.57 g of 1,4-butanadiol. This was then placed in an incubator for 10 min at a temperature of 100° C. The resulting composite was then separated from the paper. A foamed polyurethane composite with a thickness of 1300 μm and a tensile strength of 8.8 MPa was obtained.

### Example 20

The foamed polyurethane composite was prepared as follows. 50 g oligomerol with a L_{OH} hydroxyl number of 240 mgKOH/g with 50 g bio-polyol with a L_{OH} hydroxyl number of 560 mg KOH/g was mixed with 1.5 g of a 33% potassium acetate solution in ethylene glycol as catalyst, 2.5 g of 1,3,5-tris[3-(dimethylamino)propyl]hexahydro-1,3,5-triazine catalyst, 3 g of polysiloxane surfactant, 10 g of n-pentane porophore, and 10 g of citrus biomass with a grain size of 160 to 240 μm. 82 g diisocyanate (MDI) was then added and stirred for 10 s, followed by pouring this onto a textured paper to obtain a 100 μm thick layer using an applicator. This was then heated in an incubator at a temperature of 80° C. for 5 mins. A second layer with a thickness of 750 μm was then applied onto the resulting/obtained thin layer. The second layer was prepared by mixing 100 g of prepolymer with 45 g of biomass with a grain size of 150-260 μm and 8.57 g of 1,4-butanadiol. This was then placed in an incubator for 10 min at a temperature of 100° C. The resulting composite was then separated from the paper. A foamed polyurethane composite with a thickness of 850 μm and a tensile strength of 9.8 MPa was obtained.

### LIST OF COMPONENTS WITH REFERENCES

1. roll with support,
2. support,
3A, 3B, 4, 5, 6, 7—carrying roll,
8. receiving roll,
9. support receiving roll
10. composite receiving roll,
11A, 11B prepolymer tank,
12A, 12B mixer of catalysts, chain extenders and biomass,
13A, 13B dispensing pump,
14A, 14B, 14C mixing and dosing head,
15A, 15B polymer layer thickness adjuster,
16. foaming chamber,
17A, 17B drying chamber,
18. reactor for prepolymer synthesis,
19. roll with surface material,
20. surface material,
21, 22, 25 compression roll,
23. baking chamber,
24, 28A, 28B biomass dispenser,
26. roll with a layer of polyurethane with citrus fruit biomass,
27. polyurethane layer with citrus fruit biomass,
29. first layer of polyurethane with citrus fruit biomass applied onto support,
30. polyurethane layer onto which surface material is applied,
31. texture.

1.-87. (canceled)

88. The method for producing a solid polyurethane composite containing biomass formed with a layer of polyurethane prepared from oligomers, polyisocyanates, extenders, catalysts, characterised in that a layer of biomass-containing polyurethane is applied onto a support, wherein the applied layer of biomass containing polyurethane has a thickness of 50 pm to 300 pm, then this is dried in a drying chamber at a temperature of up to 80° C. to 150° C. for 1 to 180 minutes, and a subsequent layer of biomass-containing polyurethane with a thickness of 300 to 1500 pm is applied onto the dried layer of biomass-containing polyurethane onto which a surface material is applied, and then this is rolled on rolls, followed by baking in a baking chamber at a temperature of 80° C. to 50° C. for 1 to 180 minutes, after which the support is separated.

89. The method for producing a solid polyurethane composite according to claim 88,
wherein the subsequent layer contains biomass derived from citrus fruit following juice extraction, wherein the biomass consists of 0.01 to 99.99% peel, 0.01 to 99.99% pulp of oranges, mandarins, limes, lemons,
wherein the polyurethane containing the biomass and fed onto a support is prepared by mixing 1 to 99 parts by weight of petrochemical oligomerols, 1 to 99 biological oligomerols, 0.01 to 10 parts by weight of catalysts, 0.1-20 parts by weight of surfactants, and 1 to 90 parts by weight of a isocyanate agent, and 0.01 to 90 parts by weight of crushed biomass, the biomass being citrus fruit biomass following juice extraction, wherein the petrochemical oligomerols with a hydroxyl number of 30 to 700 mg KOH/g, an acid number of 0.1 to 10 mg KOH/g, a molecular weight of 100 to 6000 g/mol, and a functionality of 0.5 to 6 are used as petrochemical oligomerols, wherein the biological oligomerol is prepared by chemical liquefaction of citrus fruit biomass, wherein the chemical liquefaction process of citrus fruit biomass is conducted at a temperature of 50° C. to 250° C., for a period of 1 min to 300 mins, at a pressure of 1000 Pa to 150000 Pa and a biomass content of 1% to 90%,
wherein the catalyst used is a solution of potassium acetate in ethylene glycol, 1,3,5-tris[3-(dimethylamino)propyl]hexahydro-1,3,5-triazine,2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof,
wherein polysiloxanes or silicone oils or silicone-glycol copolymer are used as surfactants,
wherein the citrus fruit biomass is prepared by drying pulp and peel for a period of 4 to 8 h at a temperature of 90° C. to 100° C., then crushing the dried biomass into grains having 50 pm to 600 pm in size, then drying the biomass grains for a period of 2 hours at a temperature of 90° C. to 100° C. and fractionating these into grains ranging having 60 to 150 pm, 160 to 240 pm, 250 to 360 pm, 370 to 600 pm in size.

90. The solid polyurethane composite containing biomass prepared by the method according to claim 88 and formed from polyurethane layers characterised in that the polyurethane layers (29,30) are stacked one on another and have a thickness of 50 to 1500 pm, wherein each polyurethane layer (29,30) as polyols contains bio-polyols of plant origin with a molecular weight of 100-6000 g/mol, a functionality of 1 to 5 and a hydroxyl number from 30 to 600 mg KOH/g, and one surface of the combined polyurethane layers (29,30) is coated with a surface material (20), while one of the polyurethane layers (29,30) contains 1 to 90% citrus fruit biomass in crushed form.

91. The solid polyurethane composite according claim 90, wherein citrus fruit biomass is a residue remaining after the extraction of citrus fruit juice and is in the form of grains or powder wherein the biomass grains range from 50 to 600 pm in size, and wherein preferably the first layer (29) has 1 to 20%, and the subsequent layer (30) has 50 to 70% biomass and the second surface of the combined layers (29, 30) of polyurethane has the texture (31) of a citrus fruit, preferably orange peel.

92. The use of the solid polyurethane composite according to claim 88, characterised in that the solid polyurethane composite is used as a material for the manufacture of haberdashery products, in particular handbags, as well as a material for manufacturing wallets, belts as well as coverings for mattresses, armchairs, car seats and sofas.

93. A method for producing a foamed polyurethane composite containing biomass formed with a layer of polyurethane prepared from oligomers, polyisocyanates, extenders, catalysts, characterised in that a layer of biomass containing polyurethane is applied onto a support, wherein the applied layer of biomass-containing polyurethane has a thickness of 50 pm to 450 pm, followed by foaming in a foaming chamber and drying in a drying chamber at a temperature of up to 80° C. to 100° C. for 20 to 180 mins, and a subsequent layer of biomass-containing polyurethane with a thickness of 300 m to 1500 m is applied onto the dried layer of biomass-containing polyurethane onto which a surface material is applied, and then this is rolled on rolls, followed by baking in a baking chamber at a temperature of 80° C. to 150° C. for 1 to 180 minutes, after which the support is separated.

94. A method for producing a foamed polyurethane composite according to claim 93, wherein the biomass is citrus fruit biomass following juice extraction, wherein the biomass derived from citrus fruit following juice extraction consists of 0.01 to 99.99% peel, 0.01 to 99.99% pulp of oranges, mandarins, limes, lemons, wherein the citrus fruit biomass is prepared by drying pulp and peel for a period of 4 to 8 h at a temperature of 90° C. to 100° C., then crushing the dried biomass into grains having 50 pm to 600 pm in size, then drying the biomass grains for a period of 2 hours at a temperature of 90° C. to 100° C. and fractionating these into grains ranging having 60 to 150 pm, 160 to 240 pm, 250 to 360 pm, 370 to 600 pm in size,
wherein the catalyst used is a solution of potassium acetate in ethylene glycol, 1,3,5-tris[3-(dimethylamino)propyl]hexahydro-1,3,5-triazine,2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof,
wherein polysiloxanes, silicone oils, silicone-glycol copolymer are used as surfactants,
wherein the isocyanate agent used is 4,4-diphenylmethane diisocyanate (MDI), 2,4-diisocyanatoluene (TDI), hexamethylene 1,6-diisocyanate (HDI), polymeric 4,4-diphenylmethane diisocyanate (pMDI) or prepolymers with a content of unbound isocyanate groups of 2 to 30%,
wherein the polyurethane containing the biomass and fed onto a support is prepared by mixing 1 to 99 parts by weight of petrochemical oligomerols, 1 to 99 biological oligomerols, 0.01 to 10 parts by weight of catalysts, 0.1-20 parts by weight of surfactants, and 1 to 20 parts by weight of an eco-friendly foaming agent in the form of hydrocarbon fraction and water, 1 to 90 parts by weight of a isocyanate agent, and 0.01 to 90 parts by weight of ground biomass, the biomass being citrus fruit biomass following juice extraction, and wherein the petrochemical oligomerols with a hydroxyl number of 30 to 700 mg KOH/g, an acid number of 0.1 to 10 mg KOH/g, a molecular weight of 100 to 6000 g/mol, and a functionality of 0.5 to 6 are used as petrochemical oligomerols, wherein the biological oligomerol is prepared by chemical liquefaction of citrus fruit biomass conducted at a temperature of 50° C. to 250° C., for a period of 1 min to 300 mins, at a pressure of 1000 Pa to 150000 Pa and a biomass content of 1% to 90%.

95. The foamed polyurethane composite containing biomass and prepared by the method according to claim 93 and formed with polyurethane layers characterised in that the polyurethane layers (29, 30) are stacked one on another and have a thickness of 50 pm to 3500 pm, wherein the first polyurethane layer (29) is foamed, and each polyurethane layer (29, 30) as polyols contains bio-polyols of plant origin with a molecular weight of 100-6000 g/mol, a functionality of 1 to 4 and a hydroxyl number from 30 to 600 mg KOH/g, and one surface of the combined polyurethane layers (29, 30) is coated with a surface material (20), while one of the polyurethane layers (29, 30) contains 1 to 90% citrus fruit biomass in crushed form.

96. The foamed polyurethane composite according to claim 95, wherein each polyurethane layer (29, 30) comprises 1 to 90% citrus fruit biomass in crushed form, wherein preferably the first layer (29) has 1 to 20%, and the subsequent layer (30) 50 to 70% biomass and the second surface of the combined layers (29, 30) of polyurethane has the texture (31) of a citrus fruit, preferably orange peel,
wherein the plant origin bio-polyols are prepared from citrus biomass with a molecular weight of 100 to 3000 g/mol, a functionality of 1 to 5, and a hydroxyl number of 100 to 600 mgKOH/g,
wherein citrus biomass is a residue remaining after the extraction of citrus fruit juice and is in the form of grains or powder, wherein the biomass grains range from 60 to 150 pm, 160 to 240 pm, 250 to 360 pm, 370 to 600 pm in size.

97. The use of the foamed polyurethane composite according to claim 93, characterised in that the solid polyurethane composite is used as a material for the manufacture of haberdashery products, in particular handbags, as well as a material for manufacturing wallets, belts as well as coverings for mattresses, armchairs, car seats and sofas.

98. A method for producing a solid polyurethane composite containing biomass, formed with a polyurethane layer prepared using oligomers, polyisocyanates, extenders, catalysts, characterised in that a first polyurethane layer containing citrus fruit biomass is applied onto the support, wherein the applied layer of polyurethane containing biomass has a thickness of 50 pm to 300 pm, followed by a second layer of polyurethane containing citrus fruit biomass being applied onto the first layer of polyurethane containing citrus fruit biomass, wherein the second applied layer of polyurethane containing biomass has a thickness of 50 pm to 1500 pm, after which the two layers are pressed together and then dried in a drying chamber at 80° C. to 100° C. for 1 to 180 minutes, and subsequent layer of the biomass-containing polyurethane is applied, wherein the subsequent applied layer of the biomass-containing polyurethane has a thickness of 50 pm to 1500 pm, and a surface material is applied thereon, followed by rolling all the layers on rolls, and after rolling thy are baked in a baking chamber at 80° C. to 150° C. for 1 to 180 minutes, after which the support is separated.

99. A method for producing a solid polyurethane composite according to claim 98,
wherein the biomass is citrus fruit biomass following juice extraction, wherein the biomass derived from citrus fruit following juice extraction consists of 0.01 to 99.99% peel, 0.01 to 99.99% pulp of oranges, mandarins, limes, lemons, wherein the citrus fruit biomass is prepared by drying pulp and peel for a period of 4 to 8 h at a temperature of 90° C. to 100° C., then crushing the dried biomass into grains having 50 pm to 600 pm in size, then drying the biomass grains for a period of 2 hours at a temperature of 90° C. to 100° C. and fractionating these into grains ranging having 60 to 150 pm, 160 to 240 pm, 250 to 360 pm, 370 to 600 pm in size,
wherein the catalyst used is a solution of potassium acetate in ethylene glycol, 1,3,5-tris[3-(dimethylamino)propyl]hexahydro-1,3,5-triazine,2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof,
wherein the isocyanate agent used is 4,4-diphenylmethane diisocyanate (MDI), 2,4-diisocyanatoluene (TDI), hexamethylene 1,6-diisocyanate (HDI), polymeric 4,4-diphenylmethane diisocyanate (pMDI) or prepolymers with a content of unbound isocyanate groups of 2 to 30%,
wherein polysiloxanes, silicone oils, silicone-glycol copolymer are used as surfactants,
wherein the polyurethane containing the biomass and fed onto a support as first and third layers is prepared by mixing 1 to 99 parts by weight of petrochemical oligomerols, 1 to 99 biological oligomerols, 0.01 to 10 parts by weight of catalysts, 0.1 to 20 parts by weight of surfactants, 1 to 90 parts by weight of a isocyanate agent, and 0.01 to 90 parts by weight of crushed biomass, the biomass being citrus fruit biomass following juice extraction, the polyurethane containing biomass and fed onto a support as a second layer is prepared by synthesizing a prepolymer with an isocyanine group, followed by mixing with catalysts, citrus fruit biomass and an extender to form a layer with a thickness of 50 pm to 1500 pm thick, which is dried for 1 to 180 minutes at 80° C. to 150° C., followed by the gelled polyurethane being mixed with citrus fruit biomass in the form of grain or powder, wherein the biological oligomerol is prepared in the process of chemical liquefaction of citrus biomass with a hydroxyl number of 30 to 800 mg KOH/g, an acid number of 0.1 to 20 mg KOH/g, a molecular weight of 30 g/mol to 7000 g/mol, and a functionality of 1 to 4 conducted at a temperature of 50° C. to 250° C., for a time period of 1 to 300 minutes, at a pressure of 1000 Pa to 150000 Pa and a biomass content of 1% to 90%.

100. A solid polyurethane composite containing biomass prepared using the method according to claim 98, wherein the polyurethane layers (27, 29, 30) are stacked on top of each other and have a thickness of 50 pm to 3500 pm, wherein each polyurethane layer (27, 29, 30) contains as polyols plant origin bio-polyols with a molecular weight of 100 to 6000 g/mol, a functionality of 1 to 4 and a hydroxyl number of 30 to 600 mg KOH/g, while the middle polyurethane layer (27) contains 1 to 90% citrus fruit biomass in crushed form, preferably 50 to 70%, and one surface of the combined polyurethane layers (27, 29, 30) is coated with the surface material (20).

101. A solid polyurethane composite according to claim 100,
wherein the first polyurethane layer (29) comprises 1 to 90% citrus fruit biomass in crushed form, preferably 1 to 20%, the subsequent polyurethane layer (30) comprises from 1 to 90% citrus biomass in crushed form, preferably 1 to 20%, the plant origin bio-polyols are prepared from citrus biomass with a molecular weight of 100 to 3000 g/mol, a functionality of 1 to 5, and a hydroxyl number of 100 to 600 mgKOH/g, and wherein the outer surface of the combined layers (27, 29, 30) of polyurethane has the texture (31) of a citrus fruit, preferably orange peel.

102. The use of the solid polyurethane composite according to claim 98, characterised in that the solid polyurethane composite is used as a material for the manufacture of haberdashery products, in particular handbags, as well as a material for manufacturing wallets, belts as well as coverings for mattresses, armchairs, car seats and sofas

103. A method for producing a foamed polyurethane composite containing biomass, formed with a polyurethane layer prepared using oligomers, polyisocyanates, extenders, catalysts, characterised in that a first polyurethane layer containing citrus fruit biomass is applied onto the support, wherein the applied layer of polyurethane containing biomass has a thickness of 50 pm to 300 pm, followed by a second layer of polyurethane containing citrus fruit biomass being applied onto the first layer of polyurethane containing citrus fruit biomass, wherein the second applied layer of polyurethane containing biomass has a thickness of 50 pm to 1500 pm, after which the two layers are pressed together, followed by both polyurethane layers being foamed in a foaming chamber and then dried in a drying chamber at 80° C. to 100° C. for 1 to 180 minutes, and another layer of the biomass-containing polyurethane is applied, wherein the subsequent applied layer of the biomass-containing polyurethane has a thickness of 50 pm to 1500 pm, and a surface material is applied thereon, followed by rolling all the layers on rolls, and after rolling thy are baked in a baking chamber at 80° C. to 150° C. for 1 to 180 minutes, after which the support is separated.

104. A method for producing a foamed polyurethane composite according to claim 103,
wherein the biomass is citrus fruit biomass following juice extraction, wherein the biomass derived from citrus fruit following juice extraction consists of 0.01 to 99.99% peel, 0.01 to 99.99% pulp of oranges, mandarins, limes, lemons, wherein the citrus fruit biomass is prepared by drying pulp and peel for a period of 4 to 8 h at a temperature of 90° C. to 100° C., then crushing the dried biomass into grains having 50 pm to 600 pm in size, then drying the biomass grains for a period of 2 hours at a temperature of 90° C. to 100° C. and fractionating these into grains ranging having 60 to 150 pm, 160 to 240 pm, 250 to 360 pm, 370 to 600 pm in size,
wherein the catalyst used is a solution of potassium acetate in ethylene glycol, 1,3,5-tris[3-(dimethylamino)propyl]hexahydro-1,3,5-triazine,2-[2-(dimethylamino)ethoxy]ethanol, Dabco 33 LV (solution of 1,4-diazabicyclo[2.2.2]octane in ethylene glycol), stannous 2-ethylhexanoate, N,N-dimethylcyclohexylamine (DMCHA), dilaurate or mixtures thereof,
wherein polysiloxanes, silicone oils, silicone-glycol copolymer are used as surfactants,
wherein the polyurethane containing the biomass and fed onto a support as first and third layers is prepared by mixing 1 to 99 parts by weight of petrochemical oligomerols, 1 to 99 biological oligomerols, 0.01 to 10 parts by weight of catalysts, 0.1 to 20 parts by weight of surfactants, 1 to 90 parts by weight of a isocyanate agent, and 0.01 to 90 parts by weight of crushed biomass, the biomass being citrus fruit biomass following juice extraction, wherein the polyurethane containing biomass and fed onto a support as a second layer is prepared by synthesizing a prepolymer with an isocyanine group, followed by mixing with catalysts, citrus fruit biomass and an extender to form a layer with a thickness of 50 pm to 1500 pm thick, which is dried for 1 to 180 minutes at 80° C. to 150° C., followed by the gelled polyurethane being mixed with citrus fruit biomass in the form of grain or powder, wherein the biological oligomerol is prepared in the process of chemical liquefaction of citrus biomass with a hydroxyl number of 30 to 800 mg KOH/g, an acid number of 0.1 to 20 mg KOH/g, a molecular weight of 30 g/mol to 7000 g/mol, and a functionality of 1 to 4 conducted at a temperature of 50° C. to 250° C., for a time period of 1 to 300 minutes, at a pressure of 1000 Pa to 150000 Pa and a biomass content of 1% to 90%,
wherein the citrus fruit biomass in the second polyurethane layer represents 1 to 90%, the citrus fruit biomass is prepared by drying pulp and peel for a period of 4 to 8 h at a temperature of 90° C. to 100° C., then crushing the dried biomass into grains having 50 pm to 600 pm in size, then drying the biomass grains for a period of 2 hours at a temperature of 90° C. to 100° C. and fractionating these into grains ranging having 60 to 150 pm, 160 to 240 pm, 250 to 360 pm, 370 to 600 pm in size.

105. The foamed polyurethane composite containing biomass prepared using the method according to claim 103, formed with polyurethane layers, characterised in that the polyurethane layers (27, 29, 30) are stacked on top of each other and have a thickness of 50 m to 3500 pm, wherein the two polyurethane layers (27,29) are foamed, and each polyurethane layer contains as polyols plant origin bio-polyols with a molecular weight of 100 to 6000 g/mol, a functionality of 1 to 4 and a hydroxyl number of 30 to 600 mg KOH/g, while the middle polyurethane layer (27) contains citrus fruit biomass in crushed form, and one surface of the combined polyurethane layers (27, 29, 30) is coated with the surface material (20).

106. The foamed polyurethane composite according to claim 105,
wherein the first polyurethane layer (29) comprises 1 to 90% citrus fruit biomass in crushed form, preferably 1 to 20%, wherein the subsequent polyurethane layer (30) comprises 1 to 90% citrus biomass in crushed form, preferably 1 to 20%,
wherein citrus fruit biomass is a residue remaining after the extraction of citrus fruit juice and is in the form of grains or powder, the biomass grains range from 60 to 150 pm, 160 to 240 pm, 250 to 360 pm, 370 to 600 pm in size,
wherein each polyurethane layer comprises 1 to 90% citrus fruit biomass in crushed form, wherein preferably the first layer has 1 to 20%, the middle layer has 50 to 70%, and the subsequent layer has 1 to 20% biomass and wherein the outer surface of the combined layers (27,29,30) of polyurethane has the texture (31) of a citrus fruit, preferably orange peel.

107. The use of the foamed polyurethane composite according to claim 103, characterised in that the solid polyurethane composite is used as a material for the manufacture of haberdashery products, in particular handbags, as well as a material for manufacturing wallets, belts as well as coverings for mattresses, armchairs, car seats and sofas.
